(19) United States
(12) Patent Application Publication
(10) Pub. No.: US 2005/0000093 A1
(43) Pub. Date: Jan. 6, 2005

(54) Electric shaver

(76) Inventor: Simon Shagalov, Brooklyn, NY (US)

Correspondence Address: OSTROLENK FABER GERB & SOFFEN, 1180 AVENUE OF THE AMERICAS, NEW YORK, NY, 100368403, US

(21) Appl. No.: 10/613,325

(22) Filed: Jul. 3, 2003

(51) Int. Cl. B26B 19/14

(52) U.S. Cl. 30/43.6; 30/43.92

(57) ABSTRACT

An electric razor, having a housing and a cutter head mounted to the housing. The cutter head includes an elongated, longitudinally extending hair cutter assembly having a first rotatable, apertured outer cutter member, and a second, driven inner cutter member positioned in shearing engagement with the outer cutter member. A drive is provided for driving the inner cutter member. The outer cutter member is rotatable around an axis extending in the longitudinal direction of the inner cutter member.

### BACKGROUND OF THE INVENTION

The present invention relates to an electric shaver, and more particularly to an electric shaver with enhanced cutting performance.

Electric shavers generally include a hand-held housing and a cutter head. The housing is manipulated for advancing the cutting head into contact with the user's face or other body site at which hair is to be shaved. In general the cutter head includes an outer, stationary, apertured cutter member and an inner, reciprocating or rotating cutter member which operates in shearing engagement with the outer cutter member. An electrical motor is positioned in the housing and is mechanically coupled to the cutter head for imparting reciprocating or rotating motion to the inner cutter member. The user's hair which extends through the apertures in the outer cutter member are thereby sheared by the inner cutter member.

Examples of such prior art shavers are found in U.S. Pat. Nos. 4,896,420; 6,082,005; 5,685,077; 4,922,608; 4,866,843; 4,233,733; and 4,151,645, the contents of which is incorporated by reference herein. A common feature of all these prior art shavers is that the outer cutter member is stationary and during use the outer surface slides along the skin being shaved. This sliding action during shaving often results in pulling of the hair to be shaved and friction with the skin which leads to discomfort to the user.

### SUMMARY OF THE INVENTION

Accordingly, it is an object of the present invention to provide an electric shaver wherein the outer cutter member is not stationary and rotates or moves as the razor is moved along the skin during shaving.

Pursuant to this object, and others which will become apparent hereafter, one aspect of the present invention resides in an electric shaver having a housing and a cutter head mounted to the housing. The cutter head includes an elongated, longitudinally extending hair cutter assembly. The cutter assembly includes inner cutter members and an outer cutter member mounted to the cutter head so as to rotate about an axis parallel to the longitudinally extending hair cutter assembly. The inner cutter members, as is conventional, engage the inner surface of the outer cutter member for the purpose of cutting the hair passing through the outer cutter member. The inner cutter members can be any suitable type of cutters, such as vibrating or axially rotating cutters that extend in the longitudinal direction of the cutter assembly. The outer cutter member is provided with a plurality of apertures of slotted, round or any desired shape which allow the hair to be cut to pass through the outer cutter member and be sheared off by the inner cutter members.

In another embodiment of the invention the outer cutter member is a foil formed as an endless belt which travels over roller members mounted in the cutter head or housing. The inner cutter members are arranged within the outer cutter member so that as the shaver is used and moved across the skin, friction between the skin surface and the outer surface of the outer cutter member causes the outer cutter member to rotate at the same speed which the shaver is being moved by the user across the skin surface. As with a conventional shaver, as the hair passes through the apertures in the outer cutter member it is cut off by the inner cutter members. However, contrary to the conventional shavers, linear movement of the outer cutter member avoids pulling of the hair and dragging of the outer surface of the razor across the skin, as such action causes the cutter to roll, rather than slide, on the skin. This leads to greater shaving comfort.

In another embodiment of the invention the shaver has at least one longitudinally extending axially rotating inner cutter member and a cylindrical, slotted outer cutter member coaxially arranged with the inner cutter member so that the blades of the inner cutter member are in close proximity to the inner surface of the outer cutter member. The cylindrical outer cutter member is rotatable so that during movement across the face, the cylindrical outer member rotates or slides on the inner cutter as the razor is moved.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described therein.

### BRIEF DESCRIPTION OF THE DRAWINGS

FIG. 1 is a perspective view of a first embodiment of an electric shaver pursuant to the present invention;

FIG. 2 is a schematic cross-section through a cutter head component of FIG. 1;

FIG. 3 shows another embodiment of a cutter head pursuant to the present invention;

FIG. 4 shows yet another embodiment of the invention;

FIG. 5 is an exploded view of the device of FIG. 4;

FIG. 6 is a cross-section view of the cutter portion of FIG. 5; and

FIG. 7 is a perspective view of another variant embodiment of the invention.

### DETAILED DESCRIPTION OF PREFERRED EMBODIMENTS

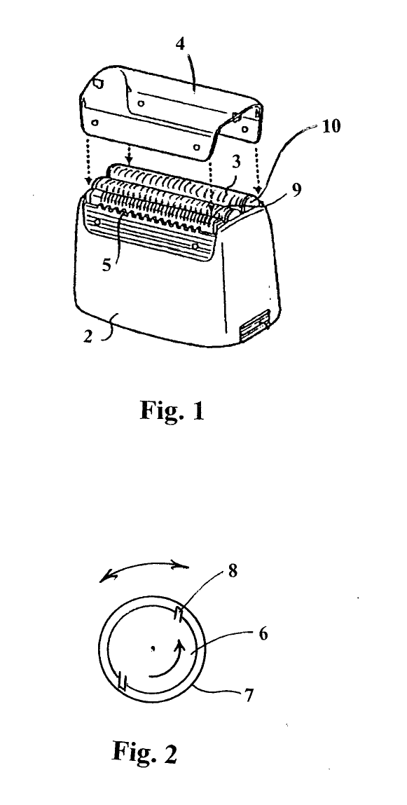

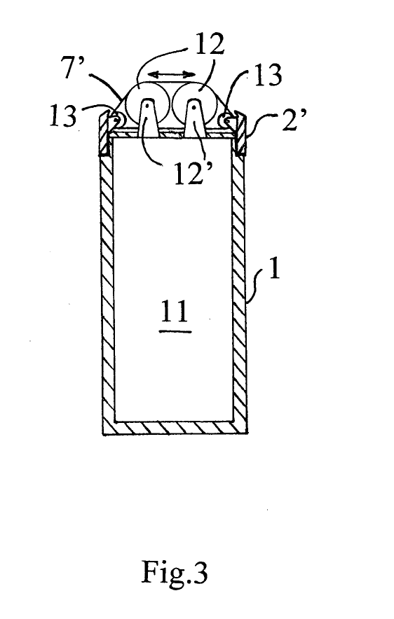

FIG. 1 illustrates a cutter head 2 for an electric razor. As is CONVENTIONAL IN THE ART, SUCH A CUTTER HEAD IS MOUNTED TO A BODY 1 WHICH IS schematically shown in cross-section in FIG. 3.

The cutter head 2 has an upper end at which longitudinally extending, parallel hair cutter assemblies 3 are arranged. A cap 4 is engagable with the cutter head 2 so as to protect the cutter assemblies 3. Furthermore, a comb-like member 5 can be provided adjacent the cutter assemblies 3 to facilitate lifting of the hair prior to encountering the cutter assemblies 3. Although FIG. 1 illustrates an embodiment having three cutter assemblies it is to be understood that the electric razor requires at least one such assembly and can have as many of these assemblies as desired.

Each of the cutter assemblies 3 is composed essentially of a rotating inner cutter member 6 and an outer cylindrical cutter member 7. The inner cutter member 6 is arranged coaxially within the cylindrical outer cutter member 7 and is driven by a motor 28 so as to rotate within the outer cutter member 7. The inner cutter member 6 has at least one blade 8 that is in close proximity to or in contact with the inner surface of the outer cutter member 7. The outer cutter member 7 is a thin foil with a plurality of slots 9 cut therein to permit passage of hair through the outer cutter 7 so that the hair can be cut by the blade 8 of the rotating inner cutter member 6. The outer cutter member 7 has a cylindrical shape and is mounted at both ends to the cutter head 2 by bearing elements 10. The outer cutter member 7 is freely rotatable on the bearings 10 so that as the shaver is moved across the skin the outer cutter member 7 rotates due to frictional contact with the skin.

A different embodiment of the electric shaver is shown in FIG. 3. In this embodiment two inner cutter members 12 are provided, although the number can be one or more. The inner cutter members 12 can either be rotating as described in connection with FIGS. 1 and 2 or vibrating cutters as are known in the art. Note drive devices 12′. One drive 12′ may rotate its cutter 12 clockwise and the other drive counter-clockwise to keep the outer cutter 7′ substantially still; except when it moves across the skin. The drive for the cutters is schematically shown as being arranged in the housing. However, it is also possible to arrange the drive in the cutter head assembly 2′ itself. The outer cutter member in this embodiment is an endless foil 7′ which has slots therein similar to the cutter of FIG. 1. The foil 7′ wraps around bearing elements or rollers 13 in the manner of an endless belt. The inner cutter members 12 are arranged inside the travel path of the belt 7′ and are in close proximity to or in contact with the inner surface of the belt 7′ so as to cut hair which passes through the slots of the belt 7′. As the shaver is moved across the skin the belt is forced to more due to friction with the skin. The movement of the belt avoids pulling the hair or dragging along the skin and thus provides a more comfortable shaving experience.

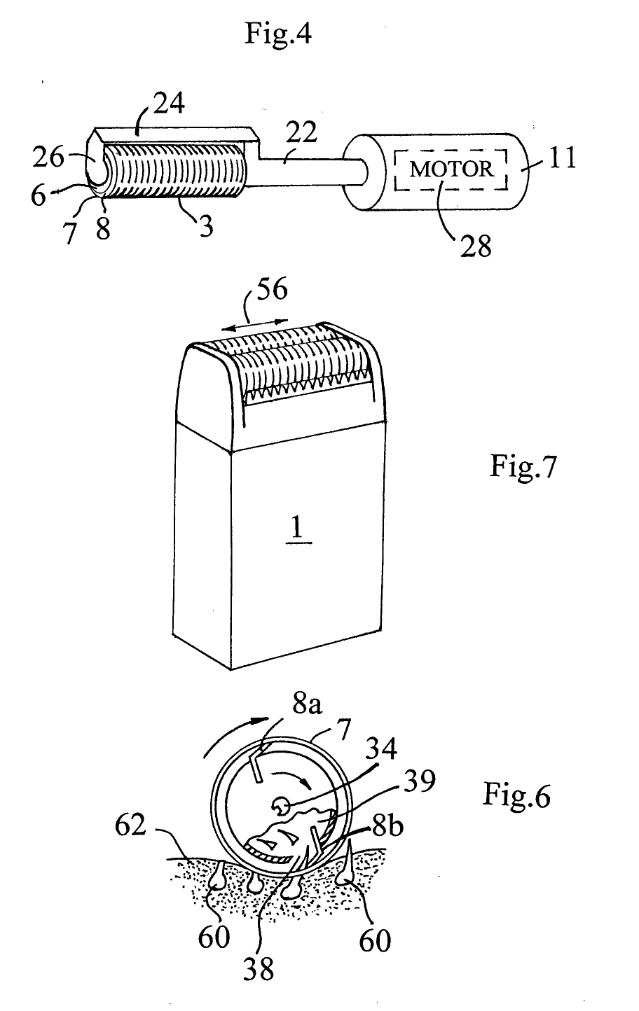

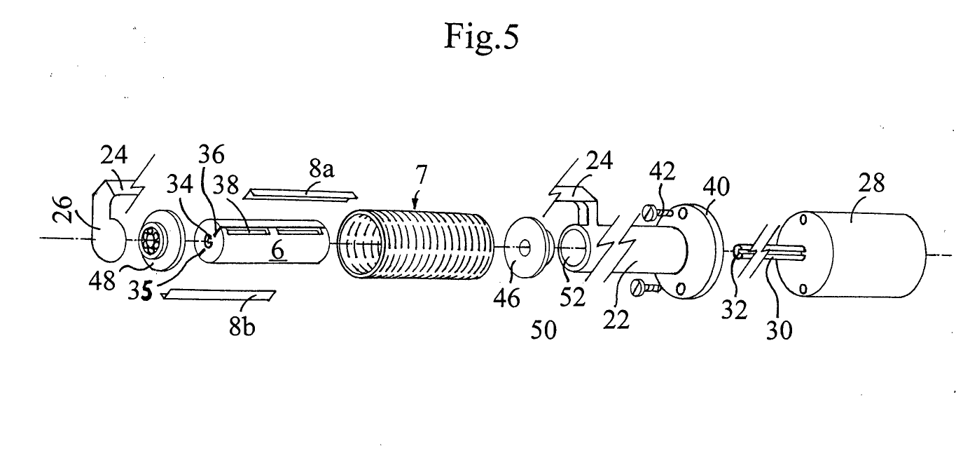

FIG. 4 shows an embodiment in which a single cutter assembly 3 is connected axially to a handle 11 and is driven by a motor 28, arranged within the handle 11. A hollow cylinder support 22 enables passage of motor shaft 40 (FIG. 5) to drive the cutter 6 that extends between the yoke 24 with its depending arm 26. The inner cutter 6 rotates inside the outer cutter foil 7, as previously described.

As more elaborately and slightly differently depicted in FIG. 5, the motor shaft 30 has a slot 32 and passes through the cylindrical support 22 to engage a corresponding slotted opening 34 in the inner cutter 6, so as to rotate the same when the motor 28 is energized. The cylinder support 22 is affixed by screws 42 that pass through a flange 40. The hollow interior 52 accommodates the shaft 30 as well as a washer 46 with a projection 50 that fits in the opening 52. The washer 46 provides an abutting surface for the cutters 6, 7 and the corresponding outer washer 48 provides the same function at the other side. The inner cutter 6 is provided with retaining slots 35, 36 that receive and loosely and removably support blades 8a and 8b. These blades rotate within the outer cutter 7 in a manner that cuts and forces the hair into the hollow interior 39 (FIG. 6) through the openings 38, and self adjusts the position of the blades against the outer cutter 7.

With reference to FIG. 6, as the cutter assembly is pressed against the skin 62, hairs 60 pass through the slots in the outer cutter 7 where they are engaged by the sharp edges of the blades 8a and 8b which contact the interior surface of outer cutter member 7. The shape of the blades gathers and directs the hair inside the chamber 39.

In FIGS. 4 and 5, the longitudinal size of the outer cutter 7 is approximately the same as the inner cutter 6. However, the outer cutter 7 can be made shorter, enabling it to freely slide on the inner cutter not only circumferentially, but longitudinally as well. Therefore, as the shaver is moved across the skin with the cutter assembly moved in any direction, the outer cutter 7 will not slide across the skin and pulling of hair is thus avoided.

In FIG. 7, an electric shaver body 1 with two cutter assemblies is illustrated with the body so arranged that the outer cutting members shown can slide axially back and forth in the direction of arrows 56 to accommodate both up and down and sideways movement of the shaver body across one's face or other body parts where hair removal is required.

Thus, while there have been shown and described and pointed out fundamental novel features of the present invention as applied to a preferred embodiment thereof, it will be understood that various omissions and substitutions and changes in the form and details of the devices illustrated, and in their operation, may be made by those skilled in the art without departing from the spirit of the present invention. For example, it is expressly intended that all combinations of those elements and/or method steps which perform substantially the same function in substantially the same way to achieve the same results are within the scope of the invention. Substitutions of elements from one described embodiment to another are also fully intended and contemplated. It is also to be understood that the drawings are not necessarily drawn to scale but that they are merely conceptual in nature. It is the intention, therefore, to be limited only as indicated by the scope of the claims appended hereto.

1. An electric shaver, comprising:
a housing;
a cutter head mounted to the housing, the cutter head including a hair cutter assembly having a first apertured and movable outer cutter member which is able to roll on a surface to be shaved, and a second, driven inner cutter member positioned in shearing engagement with the outer cutter member; and
a drive for driving the inner cutter member.

2. The electric shaver as defined in claim 1, wherein the outer cutter member includes a slotted foil cylinder coaxially arranged around the inner cutter member so that the inner cutter member is in shearing engagement with an inner surface of the outer cutter member whereby hair which extends through the outer cutter member apertures is cut by the inner cutter member.

3. The electric shaver as defined in claim 2, in the inner cutter member is a rotating cylinder having at least one blade extending therefrom so as to be in shearing engagement with the inner surface of the outer cutting member.

4. The electric shaver as defined in claim 1, wherein the cutter head is mounted axially on the housing, the drive including a motor mounted in the housing and in operative connection with the inner cutter member so as to rotate the inner cutter member.

5. The electric shaver as defined in claim 1, wherein the outer cutter member is an endless foil belt which defines a travel path, the inner cutter member being arranged within the travel path so as to be in shearing engagement with an inner surface of the belt.

6. The electric shaver as defined in claim 5, and further comprising a plurality of rollers arranged in at least one of the housing and the cutter head, the belt being looped around the rollers and the rollers being arranged so that the belt is freely movable by frictional contact with an outer surface of the belt.

7. The electric shaver as defined in claim 5, wherein the drive is arranged in the housing.

8. The electric shaver as defined in claim 5, wherein the drive is arranged in the cutter head.

9. The electric shaver as defined in claim 5, wherein the inner cutter is a rotating cutter.

10. The electric shaver as defined in claim 5, wherein the inner cutter is a reciprocating cutter.

11. The electric shaver of claim 1, in which the hair cutter assembly is elongated and extends longitudinally and the outer cutter member is rotatable around an axis extending in the longitudinal direction of the inner cutter member.

12. The electric shaver of claim 11, in which the outer cutter member is additionally mounted to slide axially relative to the inner cutter member.

13. The electric shaver of claim 1, in which the inner cutter member includes a hollow interior and an opening thereinto, through which cut hair is drawn into and collected in the hollow interior.

14. The electric shaver of claim 1, in which the inner cutter member supports a plurality of blades.

15. The electric shaver of claim 1, in which the inner cutter member is constructed and mounted to be a disposable device.
